(19) United States
(12) Patent Application Publication
(10) Pub. No.: US 2006/0035177 A1
(43) Pub. Date: Feb. 16, 2006

(54) Color developing compositions and methods of use

(75) Inventors: Shirleyanne E. Haye, Rochester, NY (US); Janet M. Huston, Webster, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/914,849

(22) Filed: Aug. 10, 2004

(51) Int. Cl. G03C 5/18

(52) U.S. Cl. 430/467

(57) ABSTRACT

Color developing compositions for photoprocessing of color photographic materials are stabilized by stabilizing composition that consists essentially of a polyphosphonic acid such as a cyclicaminomethanediphosphonic acid (or salt thereof) and at least 0.01 ppm of manganese ions.

### FIELD OF THE INVENTION

This invention relates to novel color developing compositions that have improved stability because of the incorporation of a certain stabilizing composition containing a polyphosphonic acid and manganese ions. This invention also relates to methods of using these improved color developing compositions for photoprocessing of color silver halide photographic materials.

### BACKGROUND OF THE INVENTION

The basic processes for obtaining useful color images from exposed color photographic silver halide materials include several steps of photochemical processing such as color development, silver bleaching, silver halide fixing, and water washing or dye image stabilizing using appropriate photochemical compositions.

Photographic color developing compositions are used to process color photographic materials such as color photographic films and papers to provide the desired dye images early in the photoprocessing method. Such compositions generally contain color-developing agents as reducing agents to react with suitable color forming couplers to form the desired dyes. U.S. Pat. No. 4,892,804 (Vincent et al.) describes conventional color developing compositions that have found considerable commercial success in the photographic industry. Other color developing compositions are described in U.S. Pat. No. 4,876,174 (Ishikawa et al.), U.S. Pat. No. 5,354,646 (Kobayashi et al.), and U.S. Pat. No. 5,660,974 (Marrese et al.).

It is generally known that the concentrations of various photochemicals used in a photographic color developing composition must be within certain narrow limits in order to provide optimal performance. This is particularly true of “concentrates” or single-part compositions but working strength compositions formulated from two or more “parts” must also have desired stability of their chemical reactants.

A very commercially successful single-part color developing composition that is homogeneous, concentrated, and stable is described in U.S. Pat. No. 6,077,651 (Darmon et al.).

Stability of the color developing agents is often achieved using sulfite ions or any of the many conventional organic antioxidants (or preservatives) that reduce aerial oxidation rates. For example, U.S. Pat. Nos. 4,892,804, 4,876,174, 5,354,646, and 5,660,974 (all noted above) describe hundreds of possible derivatives of hydroxylamines that can be used as antioxidants in color developing compositions.

Morpholinomethanediphosphonic acid and salts thereof are described for use in black-and-white developing compositions in U.S. Pat. No. 4,873,180 (Marchesano et al.). In addition, they have been described for stabilizing color developing compositions in U.S. Pat. No. 6,403,290 (Haye et al.).

There remains a desire in the photoprocessing industry to find additional means for stabilizing color developing compositions, whether single-part or multi-part compositions, and particularly those compositions that contain organic antioxidants such as hydroxylamines.

### SUMMARY OF THE INVENTION

This invention provides a color developing composition having a pH greater than 7 and comprising:

a) at least 0.0005 mol/l of a color developing agent,

b) at least 0.0005 mol/l of an organic antioxidant for the color developing agent, and

c) a stabilizing composition consisting essentially of at least 0.00005 mol/l of a polyphosphonic acid or a salt thereof, and at least 0.01 ppm of manganese ions.

In some embodiments, the composition of the present invention is a homogeneous, aqueous single-part color developing composition having a pH of from about 8 to about 14 and comprising:

a) from about 0.005 to about 1 mol/l of a color developing agent in free base form,

b) from about 0.005 to about 1 mol/l of a hydroxylamine derivative antioxidant for the color developing agent,

c) a water-miscible or water-soluble hydroxy-substituted, straight-chain organic solvent that has a molecular weight of from about 45 to about 300,

d) a buffering agent that is soluble in the organic solvent, and

e) a stabilizing composition consisting essentially of at least 0.0005 mol/l of a polyphosphonic acid or a salt thereof, and at least 0.1 ppm of manganese ions.

This invention also provides a multi-part color developing composition kit comprising:

(I) a first aqueous solution having a pH of from about 9 to about 13,

(II) a second aqueous solution having a pH of from about 3 to about 7 and comprising:

(a) at least 0.0005 mol/l of a color developing agent,

(b) at least 0.0005 mol/l of an organic antioxidant for the color developing agent, and

(III) an optional third aqueous solution having a pH of from about 10 to about 13.5,

wherein one or both of the first or second aqueous solutions further comprises at least 0.00005 mol/l of a polyphosphonic acid or a salt thereof, and at least one of the first, second, and third solutions contains at least 0.01 ppm of manganese ions.

Moreover, a color developing composition of the present invention has a pH greater than 7 and comprises at least 0.00005 moll of a color developing agent, and a stabilizing composition consisting essentially of at least 0.00005 mol/l of a polyphosphonic acid or a salt thereof, and at least 0.01 ppm of manganese ions.

Further, a method for providing a color image in a color photographic silver halide element comprises contacting the element with an aqueous photographic color developing composition having a pH of from about 7 to about 14 and comprising:

a) at least 0.0005 mol/l of a color developing agent,

b) at least 0.0005 mol/l of an organic antioxidant for the color developing agent, and

c) a stabilizing composition consisting essentially of at least 0.00005 mol/l of a polyphosphonic acid or a salt thereof, and at least 0.01 ppm of manganese ions.

In additional embodiments, a method of photographic processing comprises the steps of:

A) color developing an imagewise exposed color photographic silver halide element with a photographic color developing composition having a pH of from about 7 to about 14 and comprising:

a) at least 0.0005 mol/l of a color developing agent,

b) at least 0.0005 mol/l of an organic antioxidant for the color developing agent, and

c) a stabilizing composition consisting essentially of at least 0.00005 mol/l of a polyphosphonic acid or a salt thereof, and at least 0.01 ppm of manganese ions, and

B) desilvering the color developed color photographic silver halide element.

The color developing compositions of the present invention are stabilized in the presence of an organic antioxidant such as a hydroxylamine using a specific stabilizing composition consisting essentially of a polyphosphonic acid (or salt thereof), such as a cyclicaminomethanediphosphonic acid (or salt thereof), and at least 0.01 ppm of manganese ions. These advantages may be obtained to varying degrees with the various embodiments of the present invention.

### DETAILED DESCRIPTION OF THE INVENTION

In some embodiments, the color developing composition of this invention can be formulated as an aqueous concentrate, such as a single-part concentrate, that can then be diluted to form a working strength color developing composition. Alternatively, a working strength composition of this invention can be prepared by mixing all of the desired components in any desired order at working strength concentrations. Still other embodiments of this invention include two or more parts (usually two or three parts) in a color developing composition kit. Each or all parts can be in concentrated form or provided at working strength concentrations and mixed in the desired proportions to form a working strength solution. Alternatively, one or more concentrated parts can be supplied to a processing vessel as a replenishing solution.

The compositions of this invention contain one or more color developing agents that may be in the form of a sulfate salt or in free base form as a first essential component. Such color developing agents include, but are not limited to, aminophenols, p-phenylenediamines (especially N,N-dialkyl-p-phenylenediamines) and others which are well known in the art, such as EP 0 434 097A1 (published Jun. 26, 1991) and EP 0 530 921A1 (published Mar. 10, 1993). It may be useful for the color developing agents to have one or more water-solubilizing groups as are known in the art. Further details of such materials are provided in Research Disclosure, publication 38957, pages 592-639 (September 1996).

Preferred color developing agents include N,N-diethyl p-phenylenediamine sulfate (KODAK Color Developing Agent CD-2), 4-amino-3-methyl-N-(2-methane sulfonamidoethyl)aniline sulfate, 4-(N-ethyl-N-β-hydroxyethylamino)-2-methylaniline sulfate (KODAK Color Developing Agent CD-4), p-hydroxyethylethylaminoaniline sulfate, 4-(N-ethyl-N-2-methanesulfonylaminoethyl)-2-methylphenylenediamine sesquisulfate (KODAK Color Developing Agent CD-3), and 4-(N-ethyl-N-2-methanesulfonylaminoethyl)-2-methylphenylenediamine sesquisulfate. Kodak Color Developing Agent CD-3 is preferred in the processing of photographic color papers.

In preferred embodiments of single-part concentrated compositions, the color developing agents are used in “free base form” as described in U.S. Pat. No. 6,077,651 (noted above), incorporated herein by reference.

One or more antioxidants are preferably included in the color developing compositions. Inorganic or organic antioxidants can be used as long as one or more organic antioxidants are present as well. Many classes of useful inorganic antioxidants are known, including but not limited to, sulfites (such as sodium sulfite, potassium sulfite, sodium bisulfite and potassium metabisulfite). Useful organic antioxidants include hydroxylamine (and derivatives thereof), hydrazines, hydrazides, amino acids, ascorbic acid (and derivatives thereof), hydroxamic acids, aminoketones, mono- and polysaccharides, mono- and polyamines, quaternary ammonium salts, nitroxy radicals, alcohols, 1,4-cyclohexanediones, and oximes. Mixtures of compounds from the same or different classes of antioxidants can also be used if desired.

Especially useful organic antioxidants are hydroxylamine or its salts and hydroxylamine derivatives as. described for example, in U.S. Pat. No. 4,892,804 (noted above), U.S. Pat. No. 4,876,174 (noted above), U.S. Pat. No. 5,354,646 (noted above), U.S. Pat. No. 5,660,974 (noted above), and U.S. Pat. No. 5,646,327 (Burns et al.), the disclosures of which are all incorporated herein by reference with respect to antioxidants. Many of these antioxidants are mono- and dialkylhydroxylamines having one or more substituents on one or both alkyl groups. Particularly useful alkyl substituents include sulfo, carboxy, amino, sulfonamido, carbonamido, hydroxy and other solubilizing substituents. More preferably, the hydroxylamine derivatives comprise one or more sulfo, carboxy, or hydroxy solubilizing groups.

Some preferred hydroxylamine derivatives include N,N-diethylhydroxylamine, N-isopropyl-N-ethylsulfonatohydroxylamine, and N,N-di(2-ethylsulfonato)hydroxylamine. Hydroxylamine sulfate is a preferred hydroxylamine salt.

The noted hydroxylamine derivatives can also be mono- or dialkylhydroxylamines having one or more hydroxy substituents on the one or more alkyl groups. Representative compounds of this type are described for example in U.S. Pat. No. 5,709,982 (Marrese et al.), incorporated herein by reference.

Many of the noted antioxidants (organic or inorganic) are either commercially available or can be prepared using starting materials and procedures described in the references noted above.

Also present in the color developing compositions of this invention is a stabilizing composition consisting essentially of one or more polyphosphonic acids containing two or more phosphonic acid groups (or corresponding salts thereof) and manganese ions.

The preferred polyphosphonic acids are cyclicaminomethanediphosphonic acids or salts thereof. These compounds are described in U.S. Pat. No. 4,873,180 (noted above) wherein the “cyclicamino” groups comprise a substituted or unsubstituted 3- to 6-membered ring that is attached to a methyl group that includes to phosphonic acids (or salts thereof). Such rings include but are not limited to substituted or unsubstituted aziridino, pyrrolidino, imidazolidino, piperidino, piperazino, isoindolino, and morpholino groups. The substituted or unsubstituted morpholino groups are preferred. Suitable substituents for the cyclicamino groups include alkyl groups having 1 to 4 carbon atoms, halo groups, nitro groups, cyano groups, aryl groups, alkoxy groups having 1 to 4 carbon atoms, aryloxy groups, sulfamoyl groups, acyloxy groups, acylamino groups, ureido groups, sulfonamide groups, hydroxyl groups, and others that would be readily apparent to one skilled in the art from the teaching of U.S. Pat. No. 4,873,180, incorporated herein by reference.

The cyclicamino groups are attached to a methyl group that includes two phosphonic acid groups. (or alkali metal or ammonium salts thereof) and the remaining valence of the methyl group can be hydrogen, a substituted or unsubstituted alkyl group, or a substituted or unsubstituted aryl group.

Representative cyclicaminomethanediphosphonic acids (or salts thereof) are compounds 7-17 of U.S. Pat. No. 4,873,180 (noted above). A most preferred compound of this type is morpholinomethanediphosphonic acid (or a salt thereof) that is commercially available is a product known as BUDEX™ 5103 (Budenheim, Germany).

The cyclicaminomethanediphosphonic acid (or salt thereof) is present in the color developing compositions of this invention in an amount described below in TABLES I-V for the various types of compositions. The amounts will vary depending upon whether the composition is a “concentrate” or not.

Other useful polyphosphonic acids are known in the art, and are described for example in U.S. Pat. No. 4,596,765 (Kurematsu et al) and Research Disclosure publications 13410 (June, 1975), 18837 (December, 1979) and 20405 (April, 1981). Particularly useful polyphosphonic acids are the diphosphonic acids (and salts thereof) and polyaminopolyphosphonic acids (and salts thereof) described below. Useful diphosphonic acids include hydroxyalkylidene diphosphonic acids, aminodiphosphonic acids, amino-N,N-dimethylenephosphonic acids, and N-acyl aminodiphosphonic acids.

One useful class of diphosphonic acids includes hydroxyalkylidene diphosphonic acids (or salts thereof). Mixtures of such compounds can be used if desired. Useful salts include the ammonium and alkali metal ion salts. Preferred hydroxyalkylidene diphosphonic acids (or salts thereof) can be represented by the following Structure I: 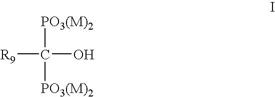
wherein R₉ is a substituted or unsubstituted alkyl group having 1 to 5 carbon atoms (methyl, methoxymethyl, ethyl; isopropyl, n-butyl, t-butyl and n-pentyl) and M is hydrogen or a monovalent cation (such as ammonium or alkali metal ions). Preferably, R₉ is methyl or ethyl, and most preferably, it is ethyl.

Representative sequestering agents of this class include, but are not limited to, 1-hydroxyethylidene-1,1-diphosphonic acid, 1-hydroxy-n-propylidene-1,1-diphosphonic acid, 1-hydroxy-2,2-dimethylpropylidene-1,1-diphosphonic acid and others that would be readily apparent to one skilled in the art (and alkali metal and ammonium salts thereof). The first compound is most preferred and is available as DEQUEST™ 2010. Its tetrasodium salt is available as DEQUEST™ 2016D. Both materials are available from Solutia Co.

Another polyphosphonic acid is a polyaminopolyphosphonic acid (or salt thereof) that has at least five phosphonic acid (or salt) groups. A mixture of such compounds can be used if desired. Suitable salts include ammonium and alkali metal (for example, sodium and potassium) ion salts. Such materials can be used as the only phosphonic acid in the second solution, but preferably they are used in combination with one or more diphosphonic acids are described above.

Preferred compounds of this nature can be represented by the following Structure II: 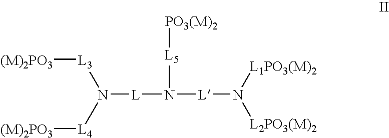
wherein L, L′, L₁, L₂, L₃, L₄ and L₅ are independently substituted or unsubstituted divalent aliphatic linking groups, each independently having 1 to 4 carbon, oxygen, sulfur or nitrogen atoms in the linking group chain. Preferably, these substituted or unsubstituted divalent linking groups have 1 to 4 carbon atoms in the linking group chain (such as substituted or unsubstituted branched or linear alkylene groups). More preferably, the divalent linking groups are independently substituted or unsubstituted methylene or ethylene. Most preferably, L and L′ are each substituted or unsubstituted ethylene (preferably unsubstituted), and each of the other linking groups is an unsubstituted methylene group. M is hydrogen or a monovalent cation (such as ammonium ion or an alkali metal salt).

A particularly useful sequestering agent of this type is diethylenetriaminepentamethylenephosphonic acid or an alkali metal salt thereof (available as DEQUEST™ 2066 from Solutia Co.).

Manganese (II) ions are provided as a suitable salt such as manganese chloride or manganese sulfate to provide at least 0.01 ppm manganese ions, preferably from about 0.01 to about 50, and more preferably from about 0.025 to about 20, ppm manganese ions. Most preferably, the manganese ions are present in an amount of from about 0.025 to about 10 ppm.

In addition, it is preferred that the ratio of mol/l of polyphosphonic acid (or salt thereof) to ppm of manganese ions be from about 0.0025:1 to about 10:1.

The color developing compositions of this invention can optionally include one or more sequestering agents for calcium or other metal ions. For example, useful calcium ion sequestering agents include polycarboxylic acids each having a molecular weight of from about 2000 to about 100,000 daltons and a plurality of carboxylic acids along the polymer chain. The molecular weight is preferably from about 2000 to about 10,000 daltons. These compounds include poly(acrylic acid), poly(methacrylic acid), poly(itaconic acid), poly(maleic acid), poly(aspartic acid), copolymers derived from the noted carboxylic acid monomers, and other carboxy-containing polyelectrolytes that would be readily apparent to one skilled in the art. Copolymers containing recurring units that do not have carboxy groups are also useful as long as sufficient recurring units contain carboxy groups. Poly(acrylic acid) and poly(acrylic acid-co-maleic acid), or salts thereof, are preferred. The polymers can also be provided in the form of alkali metal or ammonium salts.

Other useful sequestering agents include non-polymeric aminocarboxylic acids (or salts thereof). “Aminocarboxylic acids” is meant to include aminopolycarboxylic acids, polyaminopolycarboxylic acids, and polyaminocarboxylic-acids. By “non-polymeric” is meant that the compounds generally have a molecular weight less than 500 daltons.

Aminocarboxylic acids include the many compounds known in the art that are conventionally used as ferric ion bleaching agent ligands. There are many such compounds known in the art including those described in U.S. Pat. No. 4,546,068 (Kuse), U.S. Pat. No. 4,596,765 (Kurematsu et al.), U.S. Pat. No. 4,892,804 (noted above), U.S. Pat. No. 4,975,357 (Buongiorne et al.), U.S. Pat. No. 5,034,308 (Abe et al.), and Research Disclosure publications Item 20405 (April, 1981), Item 18837 (December, 1979), Item 18826 (December, 1979), and Item 13410 (December, 1975).

Examples of such compounds include, but are not limited to, ethylenediaminetetraacetic acid (EDTA), 1,3-propylenediaminetetraacetic acid (PDTA), diethylenetriaminepentaacetic acid (DTPA), cyclohexanediaminetetraacetic acid (CDTA), hydroxyethyl-ethylenediaminetriacetic acid (HEDTA), ethylenediaminedisuccinic acid (EDDS), and salts thereof, as described in U.S. Pat. No. 5,679,501 (Seki et al.) and EP-0 532,001B (Kuse et al.). Other useful disuccinic acid chelating ligands are described in U.S. Pat. No. 5,691,120 (Wilson et al.). Aminomonosuccinic acids (or salts thereof) are chelating ligands having at least one nitrogen atom to which a succinic acid (or salt) group is attached, polyamino monosuccinic acids, ethylenediamine monosuccinic acid (EDMS).

Other classes of biodegradable aminopolycarboxylic acid or polyaminopolycarboxylic acid chelating ligands that can be used to form biodegradable iron complexes include iminodiacetic acid and its derivatives (or salts thereof), including alkyliminodiacetic acids that have a substituted or unsubstituted alkyl group having 1 to 6 carbon atoms (such as methyl, ethyl, n-propyl, isopropyl, and t-butyl) as described in EP-A-0 532,003 (Kuse et al.). Particularly useful alkyliminodiacetic acids are methyliminodiacetic acid (MIDA) and ethyliminodiacetic acid (EIDA).

Still other useful aminocarboxylic acids can be represented by the following Structure II: 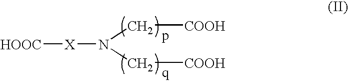
wherein p and q are independently 1, 2 and 3, and preferably each is 1. The linking group X can be H, with no carboxy group attached, or it may be any divalent group that does not bind ferric ion and does not cause the resulting ligand to be water-insoluble. Preferably, X is a substituted or unsubstituted alkylene group, substituted or unsubstituted arylene group, substituted or unsubstituted arylenealkylene group, or substituted or unsubstituted alkylenearylene group.

Still other useful aminocarboxylic acids include but are not limited to, β-alaninediacetic acid (ADA), nitrilotriacetic acid (NTA), glycinesuccinic acid (GSA), 2-pyridylmethyliminodiacetic acid (PMIDA), citric acid, tartaric acid, 1,3-diamino-2-propanetetraacetic acid (DPTA), diethylenetriaminepentaacetic acid (DTPA), and iminodisuccinic acid, and salts thereof.

It is also possible to include other metal ion sequestering agents (for example, for iron and/or copper ion sequestration) in the color developing composition as long as the other conditions of the invention are met.

One or more buffering agents are generally present in the color developing compositions to provide or maintain desired alkaline pH of from about 7 to about 14, and preferably from about 8 to about 14. These buffering agents are preferably soluble in the organic solvent described below and have a pKa of from about 9 to about 13. Such useful buffering agents include, but are not limited to carbonates, borates, tetraborates, glycine salts, triethanolamine, diethanolamine, phosphates and hydroxybenzoates. In addition to buffering agents, pH can also be raised or lowered to a desired value using one or more acids or bases such as a hydroxide. Carbonates are the preferred buffers for the single-part color developing concentrates of this invention.

A preferred component of the single-part color developing compositions of this invention is a photographically inactive, water-miscible or water-soluble, straight-chain organic solvent that is capable of dissolving color developing agents in their free base forms. Such organic solvents can be used singly or in combination, and preferably each has a molecular weight of at least 45, and preferably at least 100, and generally 300 or less and preferably 200 or less. Such preferred solvents generally have from 2 to 10 carbon atoms (preferably from 2 to 6 carbon atoms, and more preferably from 4 to 6 carbon atoms), and can additionally contain at least two nitrogen or oxygen atoms, or at least one of each heteroatom. The organic solvents are substituted with at least one hydroxy functional group, and preferably at least two of such groups. They are straight-chain molecules, not cyclic molecules.

By “photographically inactive” is meant that the organic solvents provide no substantial positive or negative effect upon the color developing function of the concentrate.

Useful organic solvents include, but are not limited to, polyols including glycols (such as ethylene glycol, diethylene glycol and triethylene glycol), polyhydroxyamines (including polyalcoholamines), and monohydroxy alcohols (such as ethanol). Glycols are preferred with ethylene glycol, diethylene glycol and triethylene glycol being most preferred. The most preferred organic solvent is diethylene glycol.

The color developing compositions of this invention can also include one or more of a variety of other addenda that are commonly used in photographic color developing compositions, including alkali metal halides (such as potassium chloride, potassium bromide, sodium bromide and sodium iodide), auxiliary co-developing agents (such as phenidone type compounds particularly for black and white developing compositions), antifoggants, development accelerators, optical brighteners (such as triazinylstilbene compounds), wetting agents, fragrances, stain reducing agents, surfactants, defoaming agents, and water-soluble or water-dispersible color couplers, as would be readily understood by one skilled in the art [see for example, Research Disclosure publications noted above]. The amounts of such additives are well known in the art also. Representative color developing compositions of this invention are described below in the examples.

It is preferred that no lithium or magnesium ions are purposely added to the color developing compositions of this invention. Depending upon the concentrations of such ions in water used to make up processing solutions, or carried over from previous processing baths, the total concentration (that is, the sum) of these ions remains preferably very low, that is less than 0.0001 mol/l in the compositions, and preferably a total of less than 0.00001 mol/l.

The following TABLES I and II list the general and preferred amounts of some components of the color developing compositions (concentrates and working strength compositions, respectively) of this invention. Useful concentrations of components not listed would be readily apparent to one skilled in the art. The preferred ranges are listed in parentheses ( ), and all of the ranges are considered to be approximate or “about” in the upper and lower end points. During color development, the actual concentrations can vary depending upon extracted chemicals in the composition, replenishment rates, water losses due to evaporation and carryover from any preceding processing bath and carryover to the next processing bath. The amounts are total concentrations for the various components that can be present in mixtures.

TABLE I
(CONCENTRATES)

| COMPONENT | CONCENTRATIONS | |
|---|---|---|
| Color developing agent(s) | 0.005-1 | mol/l |
| | (0.05-0.8 | mol/l) |
| Organic antioxidant(s) | 0.005-1 | mol/l |
| | (0.05-1 | mol/l) |
| Buffering agent(s) | 0.5-3 | mol/l |
| | (1.5-2.5 | mol/l) |
| Polyphosphonic acid (or | 0.0005-0.5 | mol/l |
| salt) | (0.001-0.25 | mol/l) |
| Manganese ions | 0.1-50 | ppm |
| | (0.5-20 | ppm) |

TABLE II
(WORKING STRENGTH)

| COMPONENT | CONCENTRATIONS | |
|---|---|---|
| Color developing agent(s) | 0.0005-0.25 | mol/l |
| | (0.005-0.2 | mol/l) |
| Organic antioxidant(s) | 0.0005-0.25 | mol/l |
| | (0.005-0.2 | mol/l) |
| Buffering agent(s) | 0.002-0.8 | mol/l |
| | (0.01-0.5 | mol/l) |
| Polyphosphonic acid (or | 0.00005-0.1 | mol/l |
| salt) | (0.0001-0.05 | mol/l) |
| Manganese ions | 0.01-20 | ppm |
| | (0.025-10 | ppm) |

The following TABLES III, IV, and V show general and preferred concentrations for multi-part color developing compositions of this invention. The stabilizing composition can be in either or both of the first and second solutions as long as it is present in at least one of those solutions. Alternatively, the polyphosphonic acid (or salt thereof) can be present in either or both of the first and second solutions and the manganese ions can be present in any or all of the three solutions. The third solution is optional so the kit can have two or three parts (solutions).

The amount of polyphosphonic acid (or salt thereof) is at least 0.00005 mol/l in the one or more solutions, and the amount of manganese ions is at least 0.01 ppm in the one or more solutions.

TABLE III
FIRST SOLUTION

| COMPONENT | CONCENTRATIONS | |
|---|---|---|
| Organic antioxidant(s) | 0-2 | mol/l |
| | (0.05-1.5 | mol/l) |
| Polyphosphonic acid (or | 0-0.5 | mol/l |
| salt) | (0-0.25 | mol/l) |
| Buffer | 0.5-3 | mol/l |
| | (1.5-2.5 | mol/l) |
| Manganese ions | 0-50 | ppm |
| | (0-20 | ppm) |

| | |
|---|---|
| pH | 9-14 |
| | (9-11) |

TABLE IV
SECOND SOLUTION

| COMPONENT | CONCENTRATIONS | |
|---|---|---|
| Color developing agent(s) | 0.0005-1 | mol/l |
| | (0.005-0.8 | mol/l) |
| Sulfite ions | 0.0001-0.5 | mol/l |
| | (0.001-0.3 | mol/l) |
| Organic antioxidant | 0-2.5 | mol/l |
| | (0.02-2 | mol/l) |
| Polyphosphonic acid (or | 0-0.5 | mol/l |
| salt) | (0-0.25 | mol/l) |
| Manganese ions | 0-50 | ppm |
| | (0-20 | ppm) |

| | |
|---|---|
| pH | 1-4 |
| | (1-3.75) |

TABLE V
THIRD SOLUTION

| COMPONENT | CONCENTRATIONS | |
|---|---|---|
| Buffer(s) | 0.5-7.5 | mol/l |
| | (1.5-6 | mol/l) |
| Organic antioxidant | 0-2.5 | mol/l |
| | (0.02-2 | mol/l) |
| Manganese ions | 0-50 | ppm |
| | (0-20 | ppm) |

| | |
|---|---|
| pH | 7-14 |
| | (10-14) |

The color developing compositions of this invention have utility to provide color development in an imagewise exposed color photographic silver halide element comprising a support and one or more silver halide emulsion layers containing an imagewise distribution of developable silver halide emulsion grains. A wide variety of types of photographic elements (both color negative and color reversal films and papers, and color motion picture films and prints) containing various types of emulsions can be processed using the present invention, the types of elements being well known in the art (see Research Disclosure publication 38957 noted above). In particular, the invention can be used to process color photographic papers of all types of emulsions including so-called “high chloride” and “low chloride” type emulsions, and so-called tabular grain emulsions as well. The color developing composition can also be particularly useful in processing of color negative films.

For example, the present invention can be used to provide color images in photographic color papers including, but not limited to, the following commercial products: KODAK® SUPRA ENDURA Color Papers (Eastman Kodak Company), KODAK® PORTRA ENDURA Color Papers (Eastman Kodak Company), KODAK® ULTRA ENDURA Color Papers (Eastman Kodak Company), KODAK® EKTACOLOR® Generations Color Papers (Eastman Kodak Company), KODAK® ROYAL® Generations Color Papers (Eastman Kodak Company), KODAK® Perfect Touch Color Paper, KODAK® PORTRA Black and White Color Paper, KODAK® ULTRA III Color Papers (Eastman Kodak Company), Fujicolor Super Color Papers (Fuji Photo Co., FA5, FA7, FA9, Type D and Type DII), Fujicolor Crystal Archive Color Papers (Fuji Photo Co., Digital Paper Type DP, Professional Paper Type DP, Professional Type CD, Professional Type CDII, Professional Type PD, Professional Type PDII, Professional Type PIII, Professional Type SP, Type One, Professional Paper Type MP, Type D and Type C), Fuji Prolaser (Fuji Photo Co.), KONICA COLOR QA Color Papers (Konica, Type QA6E and QA7, Type AD Amateur Digital, Type CD Professional Digital), Konica Color Paper Professional SP (Konica), Konica Color Paper Professional HC (Konica), Konica Color Paper Professional for Digital Type CD (Konica), Agfa Prestige Color Papers (AGFA, Digital and Prestige II), Agfa Laser II Paper (AGFA), Agfa Professional Portrait (AGFA), Agfa Professional Signum II (AGFA), Mitsubishi Color Paper SA Color Papers (Mitsubishi, Type SA-C, Type SA-PRO-L and Type SA-PRO-H).

KODAK® DURATRANS®, KODAK® DURACLEAR, KODAK® EKTAMAX RA and KODAK® DURAFLEX transparent photographic color positive materials and KODAK® Digital Paper Type 2976 can also be processed using the present invention.

Representative commercial color negative films that can be processed using the present invention include, but are not limited to, KODAK ROYAL GOLD® Color Films (especially the 1000 speed color film), KODAK GOLD MAX® Color Films, KODAK ADVANTIX® Color Films, KODAK VERICOLOR® III Color Films, KONICA VX400 Color Film, KONICA Super SR400 Color Film, KONICA CENTURIA Color Negative Films, FUJI SUPERIA and NEXIA Color Films, and LUCKY Color Films. Other elements that could be used in the practice of this invention would be readily apparent to one skilled in the art.

Color development of an imagewise exposed photographic silver halide element is carried out by contacting the element with a color developing composition of this invention under suitable time and temperature conditions, in suitable processing equipment, to produce the desired developed color image. Additional processing steps can then be carried out using conventional procedures, including but not limited to, one or more color development stop, bleaching, fixing, bleach/fixing, washing (or rinsing), stabilizing and drying steps, in any particular desired order as would be known in the art. Useful processing steps, conditions and materials useful therefor are well known for the various processing protocols including the conventional Process C-41 processing of color negative films, Process RA-4 for processing color papers and Process E-6 for processing color reversal films (see for example, Research Disclosure publication 38957 noted above), and any known modified protocols.

The color developing compositions of this invention can also be used in what are known as redox amplification processes, as described for example, in U.S. Pat. No. 5,723,268 (Fyson) and U.S. Pat. No. 5,702,873 (Twist).

Processing according to the present invention can be carried out using conventional deep tanks holding processing solutions. Alternatively, it can be carried out using what is known in the art as “low volume thin tank” processing systems, or LVTT, which have either a rack and tank or automatic tray design. These processors are sometimes included in what are known as “minilabs.” Such processing methods and equipment are described, for example, in U.S. Pat. No. 5,436,118 (Carli et al.) and publications noted therein. Some minilab processing machines are commercially available as Noritsu 2211SM Printer/Paper Processor, Noritsu 2102SM Printer/Paper Processor, and Noritsu 2301SM Printer/Paper Processor.

Color development is generally followed by desilvering using separate bleaching and fixing steps, or a combined bleach/fixing step using suitable silver bleaching and fixing agents. Numerous bleaching agents are known in the art, including hydrogen peroxide and other peracid compounds, persulfates, periodates, and ferric ion salts or complexes with polycarboxylic acid chelating ligands. Particularly useful chelating ligands include conventional polyaminopolycarboxylic acids including ethylenediaminetetraacetic acid and others described in Research Disclosure publication 38957 noted above, U.S. Pat. No. 5,582,958 (Buchanan et al.) and U.S. Pat. No. 5,753,423 (Buongiorne et al.). Biodegradable chelating ligands are also desirable because the impact on the environment is reduced. Useful biodegradable chelating ligands include, but are not limited to, iminodiacetic acid or an alkyliminodiacetic acid (such as methyliminodiacetic acid), ethylenediaminedisuccinic acid and similar compounds as described in EP 0 532,003A1 (Ueda et al.), and ethylenediamine monosuccinic acid and similar compounds as described in U.S. Pat. No. 5,691,120 (Wilson et al.). Useful fixing agents are also well known in the art and include various thiosulfates and thiocyanates or mixtures thereof as described for example in U.S. Pat. No. 6,013,424 (Schmittou et al.).

Rinsing and/or stabilizing steps can be carried out after desilvering if desired using various rinsing or stabilizing compositions that may include one or more anionic or nonionic surfactants. Representative compositions and conditions for this purpose are, for example, described in U.S. Pat. No. 5,534,396 (McGuckin et al.), U.S. Pat. No. 5,578,432 (McGuckin et al.), U.S. Pat. No. 5,645,980 (McGuckin et al.), U.S. Pat. No. 5,667,948 (McGuckin et al.), and U.S. Pat. No. 5,716,765 (McGuckin et al.).

The processing time and temperature used for each processing step of the present invention are generally, those conventionally used in the art. For example, color development is generally carried out at a temperature of from about 20 to about 60° C. The overall color development time can be up to 40 minutes, and preferably from about 10 to about 450 seconds, and more preferably from about 20 to about 120 seconds for photographic color paper and from about 30 to about 360 seconds for color negative film. Conventional conditions can be used for other processing steps including desilvering and rinsing/stabilizing. For example, desilvering can be carried out for from about 20 to about 600 seconds depending upon the type of element being processed and the other processing conditions. The color developing compositions can be replenished at a rate of from about 6 to about 2000 ml/m² of element being processed.

The color developing compositions of this invention can be used as working strength solutions, or as replenishing solutions. The concentrated compositions of this invention can be diluted at least two times (that is, one volume composition to one volume water or buffer), and preferably at least four times, and up to eight times, to provide a working strength solution or replenishing solution.

The following examples are provided to illustrate the practice of this invention and not to limit it in any way. Unless otherwise indicated, percentages are by weight.

### EXAMPLE 1

### Aeration Study of Color Developing Compositions

In this example, we monitored the stability of color developing compositions designed for color negative film processing. The compositions contained both hydroxylamine sulfate (“HAS”) and N,N-di(2-sulfoethyl)hydroxylamine (“BESHA”) as antioxidants. In addition, the compositions contained conventional metal sequestering agents and may have also contained metal ions. Each color developing composition, described below in TABLE VI below, was monitored, in replicates, under acceleration oxidation at 325 ml/min at room temperature in an opened glass container. A decrease in volume due to evaporation was compensated for by periodically adding deionized water. Each color developing composition was analyzed periodically for the amount of remaining color developing agent KODAK Color Developer CD-4, “HAS”, “BESHA”, and changes in pH. The results of these measurements are shown in the following TABLES VII and VIII. Iron (II) ions were added as ferrous chloride, and manganese (II) ions were added manganese chloride.

TABLE VI

| | Amount | | | | | | | | | |
|---|---|---|---|---|---|---|---|---|---|---|
| Component | Standard | | Comparison A | | Comparison B | | Example 2 | | Comparison C | |
| Water | 800 | ml | 800 | ml | 800 | ml | 800 | ml | 800 | ml |
| “HAS” | 2 | g | 2 | g | 2 | g | 2 | g | 2 | g |
| | (0.12 | mol/l) | (0.12 | mol/l) | (0.12 | mol/l) | (0.12 | mol/l) | (0.12 | mol/l) |
| “BESHA” | 8.4 | g | 8.4 | g | 8.4 | g | 8.4 | g | 8.4 | g |
| (33.6%) | (0.029 | mol/l) | (0.029 | mol/l) | (0.029 | mol/l) | (0.029 | mol/l) | (0.029 | mol/l) |
| DTPA (40%) | 6.4 | ml | 6.4 | ml | 0 | | 0 | | 0 | |
| BUDEX ™ 5103 | 0 | | 0 | | 3.05 | g | 3.05 | g | 3.05 | g |
| (50%) | | | | | | | | | | |
| TIRON (catechol | 0.4 | g | 0 | | 0 | | 0 | | 0 | |
| disulfonate) | | | | | | | | | | |
| Diethylene glycol | 10 | ml | 10 | ml | 10 | ml | 10 | ml | 10 | ml |
| Ethyleneurea | 3.0 | | 3.0 | | 3.0 | | 3.0 | | 3.0 | |
| KBr | 1.4 | g | 1.4 | g | 1.4 | g | 1.4 | g | 1.4 | g |
| K₂CO₃ | 39 | g | 39 | g | 39 | g | 39 | g | 39 | g |
| KODAK Color | 4.7 | g | 4.7 | g | 4.7 | g | 4.7 | g | 4.7 | g |
| Developer CD-4 | (0.016 | mol/l) | (0.016 | mol/l) | (0.016 | mol/l) | (0.016 | mol/l) | (0.016 | mol/l) |
| NaSO₃ | 4 | g | 4 | g | 4 | g | 4 | g | 4 | g |

| | | | | | | |
|---|---|---|---|---|---|---|
| Iron (II) ions | 0 | 0 | 0 | 0 | 5 | ppm |

| | | | | | | |
|---|---|---|---|---|---|---|
| Manganese (II) | 0 | 0 | 0 | 5 | ppm | 0 |
| ions | | | | | | |

| | | | | | |
|---|---|---|---|---|---|
| Water | To make 1 | To make 1 | To make 1 | To make 1 | To make 1 |
| | liter | liter | liter | liter | liter |

Each color developing composition was adjusted to pH 10.07 with H₂SO₄ or KOH.

TABLE VII

| | KODAK Color Developer CD-4 Remaining (%) | | | | |
|---|---|---|---|---|---|
| Time | Stan- | Comparison | Comparison | | |
| (hours) | dard | A | B | Example 2 | Comparison C |
| 0 | 100 | 100 | 100 | 100 | 100 |
| 24 | 81.3 | 83.3 | 83.3 | 97.9 | 81.3 |
| 48 | 68.8 | 71.9 | 70.8 | 95.8 | 72.9 |
| 72 | 54.2 | 60.4 | 58.3 | 91.7 | 62.5 |

TABLE VIII

| | BESHA Remaining (%) | | | | |
|---|---|---|---|---|---|
| Time | Stan- | Comparison | Comparison | | |
| (hours) | dard | A | B | Example 2 | Comparison C |
| 0 | 100 | 100 | 100 | 100 | 100 |
| 24 | 81.2 | 89.6 | 85.3 | 97.0 | 75.1 |
| 48 | 52.9 | 64.3 | 60.6 | 87.1 | 60.9 |
| 72 | 10.2 | 10.1 | 14.5 | 66.3 | 15.8 |

These results show that the composition of Example 1 containing a combination of BUDEX™ 5103 polyphosphonic acid and manganese (II) ions was more stable to decomposition than the Standard composition containing tiron and diethylenetriaminepentaacetic acid, pentasodium salt or the Comparison A composition without TIRON or Comparison B containing BUDEX™ 5103 as a replacement for TIRON and diethylenetriaminepentaacetic acid or Comparison C containing a combination of BUDEX™ 5105 and iron (II). A similar loss in “HAS” and a smaller loss in pH was observed in the composition of this invention.

### EXAMPLE 2

### Aeration Study of Color Developing Compositions

In this example, color developing compositions for color negative film processing were prepared containing either 5 ppm of manganese (II) ions or 5 ppm of iron (II) ions or a combination of both manganese (II) and iron (II) ions (each at 5 ppm), using the Standard color developing composition described in Example 1. Each composition, described in TABLE IX below, was monitored, in replicates, as described in Example 1. Each color developing composition was analyzed periodically for the amount of remaining color developing agent KODAK Color Developer CD-4, “HAS”, “BESHA”, and changes in pH. A summary of the remaining color developing agent in g/l at 48 hours along with the level of calcium ions sequestered by selected solutions are also shown in TABLES IX.

TABLE IX

| | Kodak CD-4 Remaining (g/l) | | | | | |
|---|---|---|---|---|---|---|
| | | | | Mn (II) & Fe (II) | Ca Titration (ppm) | |
| Color Developing Composition | No Metal | Mn (II) Ions | Fe (II) Ions | Ions | no Mn (II) | Mn (II) |
| Standard | 3.5 | 3.55 | 3.6 | 3.5 | 350 | 350 |
| Standard without ethyleneurea | 3.2/3.65 | 3.55 | 3.5 | 3.6 | | |
| Standard without TIRON | 3.3 | 3.5 | 2.2 | 1.7 | | |
| Standard without DTPA | 3.5 | 0.7 | 3.5 | 0.2 | | |
| Standard without both of DTPA & | 3.6 | 4.4 | 3.2 | 4.01 | 125 | 100 |
| TIRON | | | | | | |
| Standard without both of ethyleneurea | 3.4 | 3.05 | 2.2 | 2.5 | | |
| & TIRON | | | | | | |
| Standard without both of ethyleneurea | 3.6 | 0.3 | 3.5 | 0.3 | | |
| & DTPA | | | | | | |
| Standard without all of ethyleneurea, | 3.65/3.6 | 4.4 | 3.3 | 4.1 | 115 | 120 |
| DTPA & TIRON | | | | | | |
| Standard containing BUDEX ™ 5103 | 3.65 | 1.45 | 3.7 | 2.05 | 410 | 390 |
| but without DTPA | | | | | | |
| Standard containing BUDEX ™ 5103 | 3.5 | 4.6 | 3.5 | 4.6 | 290 | 280 |
| but without both of DTPA & TIRON | | | | | | |
| Standard containing BUDEX ™ 5103 | 3.7 | 4.5 | 3.6 | 4.6 | 305 | 310 |
| but without all of DTPA, TIRON, & | | | | | | |
| ethyleneurea | | | | | | |

The results show that the color developing compositions containing a combination of BUDEX ™ 5103 and manganese (II) ions with and without iron were the most stable compositions and provide desired calcium ion sequestration at over 250 ppm Ca (II) ions.
TIRON is catechol disulfonate.
DTPA is Diethylenetriaminepentaacetic acid, pentasodium salt (40%).

### EXAMPLES 3-5

### Using Various Amounts of Manganese (I) Ions

In this example we evaluated the use of various levels of manganese (II) ions with a fixed BUDEX™ 5103 level in color developing compositions for color negative film processing. The compositions, described below in TABLE X, were compared to the Standard color developing composition described in Example 1. All compositions were monitored under accelerated oxidation as described in Example 1. The results of these measurements are shown below in TABLES XI-XIII.

TABLE X

| | Amount | | | | | | | |
|---|---|---|---|---|---|---|---|---|
| Component | Standard | | Example 3 | | Example 4 | | Example 5 | |
| Water | 800 | ml | 800 | ml | 800 | ml | 800 | ml |
| “HAS” | 2 | g | 2 | g | 2 | g | 2 | g |
| | (0.12 | mol/l) | (0.12 | mol/l) | (0.12 | mol/l) | (0.12 | mol/l) |
| “BESHA” (33.6%) | 8.4 | g | 8.4 | g | 8.4 | g | 8.4 | g |
| | (0.029 | mol/l) | (0.029 | mol/l) | (0.029 | mol/l) | (0.029 | mol/l) |
| DTPA (40%) | 6.4 | ml | 0 | | 0 | | 0 | |
| | (0.0127 | mol/l) | | | | | | |
| BUDEX ™ 5103 | 0 | | 3.05 | g | 3.05 | g | 3.05 | g |
| (50%) | | | (0.005 | mol/l) | (0.005 | mol/l) | (0.005 | mol/l) |
| TIRON | 0.4 | g | 0 | | 0 | | 0 | |
| Diethylene glycol | 10 | ml | 10 | ml | 10 | ml | 10 | ml |
| Ethyleneurea | 3.0 | | 3.0 | | 3.0 | | 3.0 | |
| KBr | 1.4 | g | 1.4 | g | 1.4 | g | 1.4 | g |
| K₂CO₃ | 39 | g | 39 | g | 39 | g | 39 | g |
| KODAK Color | 4.7 | g | 4.7 | g | 4.7 | g | 4.7 | g |
| Developer CD-4 | (0.016 | mol/l) | (0.016 | mol/l) | (0.016 | mol/l) | (0.016 | mol/l) |
| NaSO₃ | 4 | g | 4 | g | 4 | g | 4 | g |

| | | | | | | | |
|---|---|---|---|---|---|---|---|
| Manganese (II) ions | 0 | 1 | ppm | 0.25 | ppm | 0.1 | ppm |

| | | | | |
|---|---|---|---|---|
| Water | To make 1 | To make 1 | To make 1 | To make 1 |
| | liter | liter | liter | liter |

Each color developing composition was adjusted to pH 10.07 with H₂SO₄ or KOH.

TABLE XI

| | KODAK Color Developer | | | |
|---|---|---|---|---|
| Time | CD-4 Remaining (%) | | | |
| (hours) | Standard | Example 3 | Example 4 | Example 5 |
| 0 | 100 | 100 | 100 | 100 |
| 24 | 85.1 | 91.7 | 91.5 | 89.4 |
| 48 | 76.6 | 83.3 | 85.1 | 80.9 |
| 72 | 66.0 | 79.2 | 80.9 | 72.3 |

TABLE XII

| | |
|---|---|
| Time | “BESHA” Remaining (%) |

| (hours) | Standard | Example 3 | Example 4 | Example 5 |
|---|---|---|---|---|
| 0 | 100 | 100 | 100 | 100 |
| 24 | 80.8 | 89.3 | 98.8 | 90.9 |
| 48 | 61.4 | 80.9 | 82.1 | 73.1 |
| 72 | 21.3 | 38.6 | 40.8 | 33.0 |

TABLE XIII

| | |
|---|---|
| Time | “HAS” Remaining (%) |

| (hours) | Standard | Example 3 | Example 4 | Example 5 |
|---|---|---|---|---|
| 0 | 100 | 100 | 100 | 100 |
| 24 | 52.2 | 44.9 | 41.8 | 45.5 |
| 48 | 20.2 | 26.3 | 23.5 | 20.9 |

The results show that the color developing compositions containing a combination of BUDEX™ 5103 and manganese (II) ions as low as 0.1 ppm were more stable to decomposition than the Standard color developing composition.

### EXAMPLEs 6-7

### Use of Alternative Diphosphonic Acids

Alternatively color developing compositions were formulated as in the following TABLE XIV. The color developing compositions were evaluated as described in Example 1 above and the results are described below in TABLES XV-XVII

TABLE XIV

| Component | Standard | | Example 6 | | Example 7 | |
|---|---|---|---|---|---|---|
| Water | 800 | ml | 800 | ml | 800 | ml |
| “HAS” | 2 | g | 2 | g | 2 | g |
| | (0.12 | mol/l) | (0.12 | mol/l) | (0.12 | mol/l) |
| “BESHA” | 8.4 | g | 8.4 | g | 8.4 | g |
| (33.6%) | (0.029 | mol/l) | (0.029 | mol/l) | (0.029 | mol/l) |
| DTPA (40%) | 6.4 | g | 0 | | 0 | |
| | (0.0127 | mol/l) | | | | |
| DEQUEST ™ | 0 | | 1.72 | g | 1.72 | g |
| 2010 (60%) | | | (0.005 | mol/l) | (0.005 | mol/l) |
| TIRON | 0.4 | g | 0 | | 0 | |
| Diethylene | 10 | g | 10 | g | 10 | g |
| glycol | | | | | | |
| Ethyleneurea | 3.0 | g | 3.0 | g | 3.0 | g |
| KBr | 1.4 | g | 1.4 | g | 1.4 | g |
| K₂CO₃ | 39 | g | 39 | g | 39 | g |
| KODAK Color | 4.7 | g | 4.7 | g | 4.7 | g |
| Developer | (0.016 | mol/l) | (0.016 | mol/l) | (0.016 | mol/l) |
| CD-4 | | | | | | |
| NaSO₃ | 4 | g | 4 | g | 4 | g |

| | | | | |
|---|---|---|---|---|
| Manganese | 0 | 0 | 5 | ppm |
| (II) ions | | | | |

| | | | |
|---|---|---|---|
| Water | To make 1 | To make 1 | To make 1 |
| | liter | liter | liter |

TABLE XV

| | KODAK Color Developer | | |
|---|---|---|---|
| | CD-4 Remaining (%) | | |
| Time (hours) | Standard | Example 6 | Example 7 |
| 0 | 100 | 100 | 100 |
| 24 | 85.1 | 83.3 | 95.8 |
| 48 | 76.6 | 75 | 93.8 |
| 72 | 66.0 | 62.5 | 83.3 |

TABLE XVI

| | “BESHA” Remaining (%) | | |
|---|---|---|---|
| Time (hours) | Standard | Example 6 | Example 7 |
| 0 | 100 | 100 | 100 |
| 24 | 80.8 | 84.8 | 102.2 |
| 48 | 61.4 | 61.6 | 98.2 |
| 72 | 21.3 | 24.6 | 80.9 |

TABLE XVII

| | “HAS” Remaining (%) | | |
|---|---|---|---|
| Time (hours) | Standard | Example 6 | Example 7 |
| 0 | 100 | 100 | 100 |
| 24 | 52.2 | 56.1 | 16.7 |
| 48 | 20.2 | 23.1 | 0 |

### EXAMPLE 8

### Processing Color Negative Film

Samples of conventional KODAK ROYAL® Gold 400 Color Negative Film were given a step wedge test object exposure at 1/25 sec. with a DLVA filter and a 3000°K color temperature lamp on a conventional 1B sensitometer. The film samples were then processed using the conventional Process C-41 processing conditions and either the color developing composition labeled “Standard” in Example 1 above or the color developing composition of Example 2. After full processing, the film samples were allowed to dry in the air at ambient temperature. The desired colored images were obtained in all of the film samples.

### EXAMPLE 9

### Three-Part Color Developing Kit

A color developing kit of the present invention was prepared in the following manner:

A “first” concentrated aqueous solution (Part A) was prepared by mixing sodium sulfite (0.055 mol/l), potassium bromide (0.055 mol/l), diethylene glycol (0.45 mol/l), morpholinomethanediphosphonic acid, disodium salt (0.026 mol/l), and manganese ions (1 ppm), and potassium carbonate buffer (47% solution, 1.4 mol/l). Water was added to provide 1 liter of concentrated solution. The solution pH was between 11 to 12.

A “second” concentrated aqueous solution (Part B) was prepared by mixing hydroxylamine sulfate antioxidant (1.2 mol/l), N,N-di(2-sulfoethyl)-hydroxylamine (0.29 mol/l), and diethylenetriaminepentamethylenephosphonic acid, (0.05 mol/l). Water was then added to 1 liter of solution. The solution of pH was adjusted to 3.0-3.5 using sulfuric-acid.

A “third” concentrated aqueous solution (Part C) was prepared by mixing sodium metabisulfite (0.2 mol/l) and KODAK Color Developing Agent CD-4 (0.16 mol/l) with water to 1 liter, and the solution pH was adjusted to 2.0-2.5 using sulfuric acid.

Parts A, B, and C were mixed in a volume ratio of 2:1:1 to prepare a working strength composition of the present invention.

### EXAMPLE 10

### Alternative Three-Part Color Developing Kit

Another three-part kit of this invention was prepared similar to that described in Example 8 except that BUDEX™ 5103 and manganese ions were placed in Part B (“second solution”). The three solutions were then similarly combined, diluted, and used to prepare a working strength composition of the present invention.

### EXAMPLE 11

### Alternative Three-Part Color Developing Kit

Still another three-part kit of this invention was prepared similar to that described in Example 8 except that manganese ions were placed in Part C (“third solution”). The three solutions were then similarly combined, diluted, and used to prepare a working strength composition of the present invention.

The invention has been described in detail with particular reference to certain preferred embodiments thereof, but it will be understood that variations and modifications can be effected within the spirit and scope of the invention.

1. A color developing composition having a pH greater than 7 and comprising:
a) at least 0.0005 mol/l of a color developing agent,
b) at least 0.0005 mol/l of an organic antioxidant for said color developing agent, and
c) a stabilizing composition consisting essentially of at least 0.00005 mol/l of a polyphosphonic acid or a salt thereof, and at least 0.01 ppm of manganese ions.

2. The composition of claim 1 wherein said polyphosphonic acid is a cyclicaminomethanediphosphonic acid or a salt thereof,

3. The composition of claim 1 having a pH of from about 8 to about 14, and wherein said color developing agent is present in an amount of from about 0.0005 to about 1 mol/l, and said antioxidant is a hydroxylamine derivative that is present in an amount of from about 0.0005 to about 1 mol/l.

4. The composition of claim 2 wherein said antioxidant has one or more sulfo, carboxy, or hydroxy solubilizing groups.

5. The composition of claim 1 comprising from about 0.0001 to about 0.5 mol/l of said polphosphonic acid or a salt thereof.

6. The composition of claim 1 comprising from about 0.01 to about 50 ppm of manganese ions.

7. The composition of claim 6 comprising from about 0.025 to 20 ppm of manganese ions.

8. The composition of claim 2 wherein said cyclicaminomethanediphosphonic acid comprises a cyclicamino group comprising a substituted or unsubstituted 3- to 6-membered ring that is attached to a methyl group.

9. The composition of claim 8 wherein said cyclicamino group comprises an aziridino, pyrrolidino, imidazolidino, piperidino, piperazino, isoindolino, or morpholino.

10. The composition of claim 1 wherein said cyclicaminomethanediphosphonic acid is morpholinomethanediphosphonic acid or a salt thereof.

11. The composition of claim 1 wherein said polyphosphonic acid is 1-hydroxyethylidene-1,1-disphosphonic acid or a salt thereof.

12. A homogeneous, aqueous single-part color developing composition having a pH of from about 8 to about 14 and comprising:
a) from about 0.005 to about 1 mol/l of a color developing agent in free base form,
b) from about 0.005 to about 1 mol/l of a hydroxylamine derivative antioxidant for said color developing agent,
c) a water-miscible or water-soluble hydroxy-substituted, straight-chain organic solvent that has a molecular weight of from about 45 to about 300,
d) a buffering agent that is soluble in said organic solvent, and
e) a stabilizing composition consisting essentially of at least 0.0005 mol/l of a polyphosphonic acid or a salt thereof, and at least 0.1 ppm of manganese ions.

13. The composition of claim 12 comprising from about 0.05 to about 0.8 mol/l of a color developing agent in free base form, from about 0.05 to about 1 mol/l of a hydroxylamine derivative antioxidant for said color developing agent, said organic solvent is a glycol, and wherein said stabilizing composition consists essentially of from about 0.001 to about 0.25 mol/l of a cyclicaminomethanediphosphonic acids or a salt thereof, and from about 0.5 to about 20 ppm of manganese ions.

14. A multi-part color developing composition kit comprising:
(I) a first aqueous solution having a pH of from about 9 to about 13,
(II) a second aqueous solution having a pH of from about 3 to about 7 and comprising:
(a) at least 0.0005 mol/l of a color developing agent,
(b) at least 0.0005 mol/l of an organic antioxidant for said color developing agent,
(III) an optional third aqueous solution having a pH of from about 10 to about 13.5,
wherein one or more of said first or second aqueous solutions further comprises at least 0.00005 mol/l of a polyphosphonic acid or a salt thereof, and at least one of said first, second, and third aqueous solutions contains at least 0.01 ppm of manganese ions.

15. A color developing composition having a pH greater than 7 and comprising at least 0.0005 mol/l of a color developing agent, and
a stabilizing composition consisting essentially of at least 0.00005 mol/l of a polyphosphonic acid or a salt thereof, and at least 0.01 ppm of manganese ions.

16. A method for providing a color image in a color photographic silver halide element comprising contacting said element with an aqueous photographic color developing composition having a pH of from about 7 to about 14 and comprising:
a) at least 0.0005 mol/l of a color developing agent,
b) at least 0.0005 mol/l of an organic antioxidant for said color developing agent, and
c) a stabilizing composition consisting essentially of at least 0.00005 mol/l of a polyphosphonic acid or a salt thereof, and at least 0.01 ppm of manganese ions.

17. The method of claim 16 further comprising desilvering said color developed color photographic silver halide element.

18. The method of claim 16 wherein said photographic color silver halide element is a photographic color paper or color negative film.

19. The method of claim 16 carried out in a minilab.

20. The method of claim 16 wherein a digital image is obtained after said contact with said aqueous color developing composition.

21. The method of claim 16 wherein said color development composition is replenished at a rate of from about 6 to about 2000 ml/m² of processed color photographic silver halide element, color development is carried out for from about 10 to about 450 seconds, and further comprising desilvering that is carried out for from about 20 to about 600 seconds.
